(19) United States
(12) Patent Application Publication
(10) Pub. No.: US 2007/0219783 A1
(43) Pub. Date: Sep. 20, 2007

(54) Bilingual dictionary creating apparatus, bilingual dictionary creating method and computer program

(75) Inventor: Masashi Sakamoto, Nara (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/653,360

(22) Filed: Jan. 16, 2007

(30) Foreign Application Priority Data
Mar. 16, 2006 (JP) 2006-72062

(51) Int. Cl. G06F 17/21

(52) U.S. Cl. 704/10

(57) ABSTRACT

According to the present invention, there is provided a bilingual dictionary creating apparatus 100, a bilingual dictionary creating method and a computer program. The bilingual dictionary creating apparatus 100 creates a new bilingual dictionary by using a bilingual corpus including plural pairs of strings shown in both a source language and a target language and using an existing bilingual dictionary. The bilingual dictionary creating apparatus 100 includes: a fragment pair creating section 130 for creating a fragment pair by deleting a translation pair registered in the existing bilingual dictionary from the pairs of strings; a fragment pair saving section 140 for saving the fragment pair and the number of appearances of the fragment pair in the bilingual corpus counted; and a fragment pair extracting section 160 for extracting the fragment pair having the number of appearances with a threshold or more to create a dictionary-registration candidate translation pair.

### CROSS-REFERENCE TO RELATED APPLICATION

The disclosure of Japanese Patent Application No. JP2006-72062 filed on Mar. 16, 2006, including the specification, drawings and abstract is incorporated herein by reference in its entirety.

### BACKGROUND OF THE INVENTION

The present invention relates to a bilingual dictionary creating apparatus, bilingual dictionary creating method and computer program.

For performing machine translation translating a sentence in a certain language into another language automatically and performing cross-lingual retrieval capable of retrieving sentences written in other languages by native language, by computer processing, a large number of bilingual dictionaries computerized to be used in computer processing are required.

Conventionally, to obtain such a bilingual dictionary, there has been created generally by hand. To create a sufficient amount of bilingual dictionaries by hand, however, it is necessary for an operator having a considerable knowledge of both languages in each of the bilingual dictionaries to create taking a long time, which increases the cost such as workload and working hours.

To reduce the above cost, there has been developed a method for extracting automatically a translation pair by using statistical information such as appearance frequency of a word in a corpus. In this method, however, since it is assumed that “a phrase in a bilingual relation between a certain language and another language is associated with appearance frequency”, it is necessary for the candidate of phrase in a bilingual relation to appear at a certain degree of frequency in the sentences in each language. For this reason, the above method does not function without existence of large amount of corpuses. Note that the above corpus indicates the one with electronically-stored example sentence texts accumulated.

With such a problem, the method using statistical information is still being in research and development and only applied experimentally for a phrase with comparatively high degree of appearance frequency. The phrase which cannot be obtained by the conventional manual operation has generally the appearance frequency at quite lower degree than the phrase to be a target of experiment as above. In order to extract automatically the phrase that cannot be obtained by the manual operation, there is required a huge amount of corpuses in which even the phrase with very low degree of appearance frequency appears more than once.

As an apparatus for extracting a phrase with low degree of appearance frequency, there is disclosed in, for example, Japanese Patent No. 3,282,789 (hereafter, referred to as document 1), an apparatus for extracting a translation pair accurately by estimating and comparing the phonemes of two languages. According to the apparatus in the document 1, even a translation pair with small number of appearances can be obtained easily if the phonemes are similar like “Smith” and “Sumisu”. It should be noted that “Sumisu” in Japanese means “Smith” in English.

In the apparatus in Japanese Patent Laid-open Publication No. 2004-348514 (hereafter, referred to as document 2), focusing the fact that the patent gazette is not only advanced in digitization but also defines its format comparing a general document, there is performed the operation where the patent gazettes in two languages are paired to extract the reference numbers in the gazettes and to extract nouns before the same reference numbers as a translation pair.

The above two apparatuses, which operates even when the translation pair appears in the sentences in each language at small degree of frequency, aim at solving the problem with the method of extracting automatically a translation pair by using statistical information.

In the method in the above document 1, however, although the translation pair “steel” and “suti:ru” can be obtained, the translation pair “steel” and “hagane” cannot be obtained, which causes the translation pair to be limited to the pair of so-called imported word and its original word. It should be noted that “suti:ru” in Japanese means” steel” in English and “hagane” in Japanese means “steel” in English.

Also, the method in the above document 2 functions when the patent specification filed in Japanese is filed for also U.S. application translated into English without changing even reference numbers. However, the method does not function when the structure of specification is also changed in translating into English.

### SUMMARY OF THE INVENTION

The present invention is achieved in view of the aforementioned problems and aims at providing novel and improved bilingual dictionary creating apparatus, bilingual dictionary creating method and computer program capable of extracting automatically a translation pair with low degree of appearance frequency.

According to the first aspect of the present invention, there is provided a bilingual dictionary creating apparatus for creating a new bilingual dictionary by using a bilingual corpus including plural pairs of strings shown in both a source language and a target language and using an existing bilingual dictionary, the bilingual dictionary creating apparatus including: a fragment pair creating section for creating a fragment pair by deleting a translation pair registered in the existing bilingual dictionary from the pairs of strings; a fragment pair saving section for saving the fragment pair and the counted number of appearances of the fragment pairs in the bilingual corpus in the storing section; and a fragment pair extracting section for extracting the fragment pair having the number of appearances with a threshold or more from the storing section to create a dictionary-registration candidate translation pair.

With such a configuration, the fragment pair creating section deletes the translation pair registered in the existing bilingual dictionary from plural pairs of strings shown in both a source language and a target language included in the bilingual corpus to create the fragment pair. The fragment pair saving section saves the fragment pair created in the fragment pair creating section in the storing section, associating with the number of appearances in the bilingual corpus. The fragment pair extracting section extracts the fragment pair having the number of appearances with a threshold or more from the fragment pair saved in the storing section to create a dictionary-registration candidate translation pair. As a result, the translation pair that has not been registered yet in the bilingual dictionary can be selected.

To solve the above problems, according to the second aspect of the present invention, there is provided a bilingual dictionary creating apparatus for creating a new bilingual dictionary by using a bilingual corpus including plural pairs of strings shown in both a source language and a target language and using an existing bilingual dictionary, the bilingual dictionary creating apparatus including: a fragment pair creating section for creating a fragment pair by deleting a translation pair registered in the existing bilingual dictionary from the pairs of strings; a fragment pair saving section for saving the fragment pair and the counted number of appearances of the fragment pair in the bilingual corpus in the storing section; a fragment pair extracting section for extracting the fragment pair having the number of appearances with a threshold or more from the storing section; and a dictionary-registration candidate creating section for deleting the extracted fragment pair and the translation pair from the plural pairs of strings shown in both the input source language and target language.

With such a configuration, the fragment pair creating section deletes the translation pair registered in the existing bilingual dictionary from plural pairs of strings shown in both a source language and a target language to create the fragment pair. The fragment pair saving section saves the created fragment pair in the storing section, associating with the number of appearances of the fragment pair in the bilingual corpus. The fragment pair extracting section extracts the fragment pair having the number of appearances with a threshold or more from the fragment pair saved in the storing section. The dictionary-registration candidate creating section deletes the extracted fragment pair and the translation pair from the plural pairs of strings shown in both the input source language and target language. As a result, the translation pair with low degree of appearance frequency that has not been registered yet in the bilingual dictionary can be selected.

The fragment pair extracting section may further delete the dictionary-registration candidate translation pair from the fragment pair stored in the storing section to extract a new dictionary-registration candidate translation pair. With such a configuration, the fragment pair extracting section further deletes the dictionary-registration candidate translation pair from the fragment pair stored in the storing section to extract a part of the fragment pairs remaining without deleted as a new dictionary-registration candidate translation pair. As a result, there can be extracted the unregistered translation pair not reaching a threshold at the time of extracting the fragment pair.

The threshold may be determined by a difference in number indicating the number of types of the fragment pair and a total number of the fragment pair.

The extraction level of the fragment pair may be changed by making it possible to change freely the threshold.

The bilingual corpus may be created targeting a title of a technical literature shown in both the source language and the target language. For example, the title of technical literature such as patent gazette, which has a shorter sentence than in the main body, includes many technical terms. For this reason, the bilingual corpus well-balanced between the source language and the target language can be created.

To solve the above problems, according to the third aspect of the present invention, there is provided a bilingual dictionary creating method for creating a new bilingual dictionary by using a bilingual corpus including plural pairs of strings shown in both a source language and a target language and using an existing bilingual dictionary, the bilingual dictionary creating method including the steps of: (a) creating a fragment pair by deleting a translation pair registered in the existing bilingual dictionary from the pairs of strings; (b) saving the fragment pair and the counted number of appearances of the fragment pair in the bilingual corpus in the storing section; and (c) extracting the fragment pair having the number of appearances with a threshold or more to create a dictionary-registration candidate translation pair.

With such a configuration, in the step (a), there is deleted the translation pair registered in the existing bilingual dictionary from plural pairs of strings shown in both a source language and a target language included in the bilingual corpus to create the fragment pair. In the step (b), there is saved the fragment pair created in the fragment pair creating section in the storing section, associated with the number of appearances in the bilingual corpus. In the step (c), there is extracted the fragment pair having the number of appearances with a threshold or more from the fragment pair saved in the storing section to create a dictionary-registration candidate translation pair. As a result, the pair of strings with low degree of appearance frequency that has not been registered yet in the bilingual dictionary can be selected.

To solve the above problems, according to the fourth aspect of the present invention, there is provided a bilingual dictionary creating method for creating a new bilingual dictionary by using a bilingual corpus including plural pairs of strings shown in both a source language and a target language and using an existing bilingual dictionary, the bilingual dictionary creating method including the steps of: (a) creating a fragment pair by deleting a translation pair registered in the existing bilingual dictionary from the pairs of strings; (b) saving the fragment pair and the counted number of appearances of the fragment pair in the bilingual corpus in the storing section; (c) extracting the fragment pair having the number of appearances with a threshold or more from the storing section; and (d) deleting the extracted fragment pair and the translation pair from the pairs of strings to create a dictionary-registration candidate translation pair.

With such a configuration, in the step (a), there is deleted the translation pair registered in the existing bilingual dictionary from plural pairs of strings shown in both a source language and a target language included in the bilingual corpus to create the fragment pair. In the step (b), there is saved the fragment pair created in the fragment pair creating section in the storing section, associated with the number of appearances in the bilingual corpus. In the step (c), there is extracted the fragment pair having the number of appearances with a threshold or more from the fragment pair saved in the storing section to create a dictionary-registration candidate translation pair. In the step (d), there are deleted the extracted fragment pair and the translation pair extracted in the step (c) from the pairs of strings to create a dictionary-registration candidate translation pair. As a result, the translation pair with low degree of appearance frequency that has not been registered yet in the bilingual dictionary can be selected.

There may be included a step of further narrowing down the created plural dictionary-registration candidate translation pairs created in the above steps based on the appearance frequency in the bilingual corpus. In the above step, with this configuration, the created plural dictionary-registration candidate translation pairs are ranked based on the appearance frequency in the bilingual corpus. As a result, the dictionary-registration candidate translation pair suitable for dictionary registration can be further narrowed down from among the newly-extracted dictionary-registration candidate translation pairs.

The threshold may be determined by a difference in number indicating the number of types of the fragment pair and a total number of the fragment pair.

To solve the above problems, according to the fifth aspect of the present invention, there is provided a computer program for making a computer function as the bilingual dictionary creating apparatus as described above. The computer program is stored in a storing section in the computer and makes the computer function as the bilingual dictionary creating apparatus by being executed upon loading by a CPU in the computer. In addition, there can be provided a recording medium with the computer program recorded and readable by a computer. The recording medium includes, for example, magnetic disk, optical disk and so on.

According to the present invention, it is possible to extract automatically a translation pair with low degree of appearance frequency in a bilingual corpus such as technical term.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments.

FIG. 1 is a view showing a frame format of a bilingual dictionary creating apparatus according to the first embodiment of the present invention.

FIG. 2 is a flowchart of an operation of the bilingual dictionary creating apparatus according to the first embodiment of the present invention.

FIG. 3 is a flowchart of an operation of a fragment pair creating section according to the first embodiment of the present invention.

FIG. 4 is a view showing a frame format of an operation of the fragment pair creating section according to the first embodiment of the present invention.

FIG. 5 is a flowchart of an operation of a fragment pair saving section according to the first embodiment of the present invention.

FIG. 6 is a view showing a frame format of an operation of the fragment pair saving section according to the first embodiment of the present invention.

FIG. 7 is a flowchart of an operation of a fragment pair extracting section according to the first embodiment of the present invention.

FIG. 8 is a view showing a frame format of an operation of the fragment pair extracting section according to the first embodiment of the present invention.

FIG. 9 is a flowchart of an operation of a dictionary-registration candidate creating section according to the first embodiment of the present invention.

FIG. 10 is a view showing a frame format of an operation of the dictionary-registration candidate creating section according to the first embodiment of the present invention.

FIG. 11 is a flowchart of an operation of a dictionary-registration candidate extracting section according to the first embodiment of the present invention.

### DETAILED DESCRIPTION OF THE PREFERRED EMBODIMENTS

Hereinafter, the preferred embodiment of the present invention will be described in reference to the accompanying drawings. Same reference numerals are attached to components having same functions in following description and the accompanying drawings, and a description thereof is omitted.

### (Configuration of a Bilingual Dictionary Creating Apparatus)

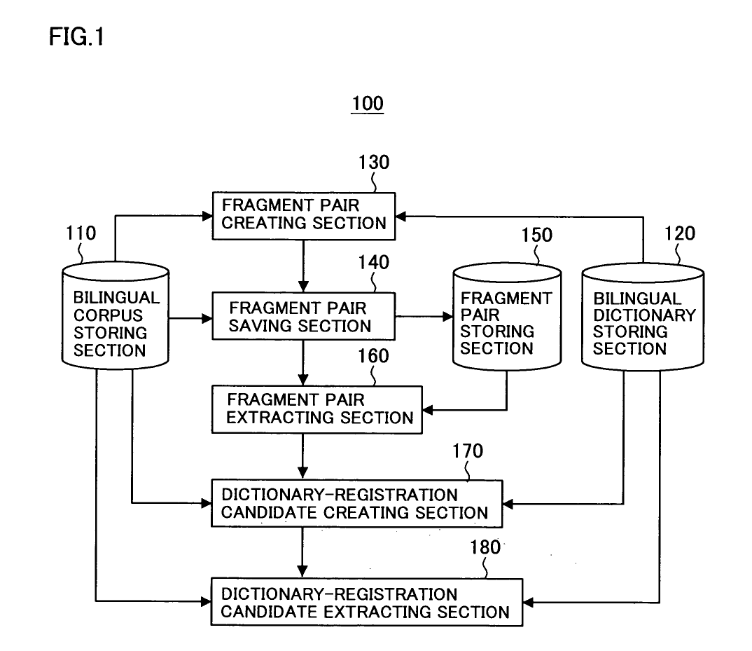

First, the configuration of a bilingual dictionary creating apparatus 100 according to the first embodiment of the present invention will be described in reference to FIG. 1. FIG. 1 is a view showing a frame format of the bilingual dictionary creating apparatus 100 according to this embodiment.

The bilingual dictionary creating apparatus 100 according to this embodiment includes: a bilingual corpus storing section 110; a bilingual dictionary storing section 120; a fragment pair creating section 130; a fragment pair saving section 140; a fragment pair storing section 150; a fragment pair extracting section 160; a dictionary-registration candidate creating section 170; and a dictionary-registration candidate extracting section 180.

The bilingual corpus storing section 110 can store one or more bilingual corpuses including plural pairs of strings shown in both a source language and a target language to be input to the bilingual dictionary creating apparatus 100.

The bilingual dictionary storing section 120 can store one or more existing bilingual dictionaries to be input to the bilingual dictionary creating apparatus 100. In the existing bilingual dictionaries, plural translation pairs shown in both a source language and a target language are registered.

The fragment pair creating section 130 is a processing section for creating a fragment pair by referring to the bilingual corpuses saved in the bilingual corpus storing section 110 and the bilingual dictionaries saved in the bilingual dictionary storing section 120. For example, when the plural pairs of strings included in the bilingual corpuses stored in the bilingual corpus storing section 110 include the translation pairs that have been already registered in the bilingual dictionaries stored in the bilingual dictionary storing section 120, the fragment pair creating section 130 can delete the translation pairs registered in the bilingual dictionary from the pairs of strings to output the pairs of strings remaining without deleted as the fragment pairs.

The fragment pair saving section 140 is a processing part for counting the number of appearances of the fragment pairs input from the fragment pair creating section 130 in the bilingual corpuses stored in the bilingual corpus storing section 110 and for storing upon the end of counting the obtained number of appearances in the fragment pair storing section 150 with the input fragment pairs. In the fragment pair storing section 150, as a result, the fragment pairs input from the fragment pair creating section 130 are to be saved associated with the number of appearances in the bilingual corpus.

The fragment pair extracting section 160 counts a difference in number of the fragment pairs stored in the fragment pair storing section 150 and the total number of the fragment pairs by referring to the fragment pair storing section 150. Then the fragment pair extracting section 160 calculates a threshold according to the difference in number and total number of the fragment pairs to extract the fragment pairs having the number of appearances with the calculated threshold or more from among the fragment pairs stored in the fragment pair storing section 150 and to output them.

Since the fragment pairs having the number of appearances with the threshold or more output from the fragment pair extracting section 160 can be considered as the translation pairs with a certain number of appearances or more that are not registered in the existing bilingual dictionaries, the fragment pairs having the number of appearances with this threshold or more may be regarded as dictionary-registration candidate translation pairs to be potentially registered in the bilingual dictionaries.

The dictionary-registration candidate creating section 170 is a processing part for outputting the translation pairs with low degree of appearances not being registered in the bilingual dictionaries as the dictionary-registration candidate translation pairs by using the fragment pairs output from the fragment pair extracting section 160, the bilingual corpuses stored in the bilingual corpus storing section 110 and the bilingual dictionaries stored in the bilingual dictionary storing section 120. When the plural pairs of strings in the bilingual corpuses stored in the bilingual corpus storing section 110 include both or either one of the translation pairs registered in the bilingual dictionaries stored in the bilingual dictionary storing section 120 and the fragment pairs output from the fragment pair extracting section 160, the dictionary-registration candidate creating section 170 can delete the translation pairs and the fragment pairs from the pairs of strings to output the pairs of strings remaining without deleted as the dictionary-registration candidate translation pairs.

The dictionary-registration candidate extracting section 180 can further narrow down the dictionary-registration candidate translation pairs input from the dictionary-registration candidate creating section 170 to extract newly the translation pairs suitable for dictionary registration. There are no method of narrowing down the dictionary-registration candidate translation pairs with high accuracy and high degree of reliability, many kinds of which are being examined. The dictionary-registration candidate extracting section 180 can be implemented according to the factor including the purpose of use such as: type and amount of the bilingual corpuses having extracted the dictionary-registration candidate translation pairs; the degree of manual check for the dictionary-registration candidate translation pairs narrowed down by the dictionary-registration candidate extracting section 180; and whether the extracted dictionary-registration candidate translation pairs will be used for machine translation or cross-lingual retrieval. In addition, the dictionary-registration candidate extracting section 180 does not need to be implemented according to the purpose of use.

Provision of the fragment pair creating section 130, the fragment pair saving section 140, the fragment pair extracting section 160, the dictionary-registration candidate creating section 170 and the dictionary-registration candidate extracting section 180 makes it possible for the bilingual dictionary creating apparatus 100 according to this embodiment to extract automatically the pair of strings with low degree of appearance that has not been registered yet in the existing bilingual dictionaries as a new translation pair and to reduce various workloads for creating a new bilingual dictionary.

### (Operation in Bilingual Dictionary Creating Apparatus)

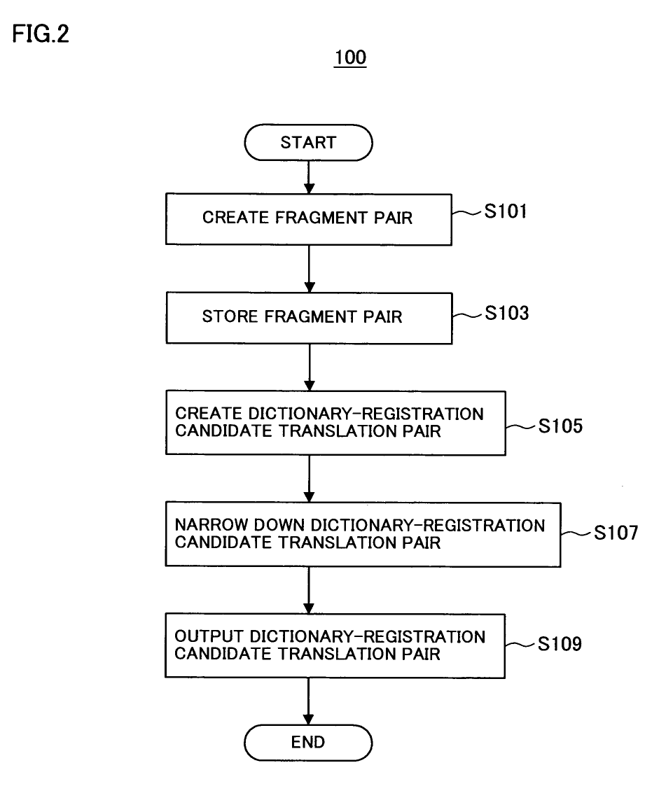

Hereinafter, the operation in a bilingual dictionary creating apparatus 100 according to this embodiment will be described in reference to FIG; 2. FIG. 2 is a flowchart of an operation of the bilingual dictionary creating apparatus 100 according to this embodiment.

In this operation, the bilingual corpus including plural pairs of strings shown in both a source language and a target language and the existing bilingual dictionary are input to the bilingual dictionary creating apparatus 100 in advance. Thereby the bilingual corpus is stored in the bilingual corpus storing section 110 and the bilingual dictionary is stored in the bilingual dictionary storing section 120.

First, the bilingual dictionary creating apparatus 100 creates a fragment pair from the pairs of strings included in the bilingual corpus by referring to the bilingual corpus stored in the bilingual corpus storing section 1 10 and the bilingual dictionary stored in the bilingual dictionary storing section 120 (S101). Such an operation of creating a fragment pair is performed in the fragment pair creating section 130 in the bilingual dictionary creating apparatus 100.

Next, the bilingual dictionary creating apparatus 100 stores the obtained fragment pair in the fragment pair storing section 150 (S 103) to allow the stored fragment pair to be used by reference in the following operations. Such an operation of storing a fragment pair is performed in the fragment pair saving section 140 in the bilingual dictionary creating apparatus 100.

Then the bilingual dictionary creating apparatus 100 creates dictionary-registration candidate translation pairs by referring to the bilingual corpus stored in the bilingual corpus storing section 110, the bilingual dictionary stored in the bilingual dictionary storing section 120 and the fragment pair stored in the fragment pair storing section 150 (S 105). Such an operation of creating dictionary-registration candidate translation pairs is performed in the fragment pair extracting section 160 and the dictionary-registration candidate creating section 170 in the bilingual dictionary creating apparatus 100.

In the next, the bilingual dictionary creating apparatus 100 narrows down the obtained dictionary-registration candidate translation pairs to extract the translation pairs suitable for dictionary-registration (S107).

Finally, the bilingual dictionary creating apparatus 100 outputs the dictionary-registration candidate translation pairs obtained by narrowing down to, for example, a monitor and a file (S109). Such an operation of narrowing down and then outputting the dictionary-registration candidate translation pairs is performed in the dictionary-registration candidate extracting section 180 in the bilingual dictionary creating apparatus 100.

Hereinafter, there will be described specifically the operations in the fragment pair creating section 130, the fragment pair saving section 140, the fragment pair extracting section 160, the dictionary-registration candidate creating section 170 and the dictionary-registration candidate extracting section 180 in reference to the example of setting Japanese as the source language and English as the target language.

In the bilingual dictionary creating apparatus 100 according to this embodiment, the following processes are preformed by using, for example, the bilingual corpus with the title in Japanese and the counterpart in English and by using the created bilingual dictionary.

In creating the above bilingual corpus, for example, it is possible to use the title in a technical literature such as patent gazette having short sentences but including many terms such as technical term. Using the title in such a document as the bilingual corpus makes it possible to create the bilingual corpus in which Japanese as the source language and English as the target language correlate very well with each other.

In the following concrete example, it is assumed that there is stored in the bilingual corpus storing section 110 the bilingual corpus including three pairs of strings:
┌ [symbol] [symbol] insulating film excellent in heat resistance┘;
┌ [symbol] [symbol] electronic apparatus excellent in heat resistance┘; and
┌ [symbol] [symbol] electronic apparatus excellent in surge strength┘. Note that ┌ [symbol] [symbol] insulating film excellent in heat resistance┘ is abbreviated as a first pair, ┌ [symbol] [symbol] electronic apparatus excellent in heat resistance┘ as a second pair and ┌ [symbol] [symbol] electronic apparatus excellent in surge strength as a third pair. It should also be noted that ┌ [symbol] [symbol] ┘ in Japanese means “insulating film excellent in heat resistance” in English, ┌ [symbol] [symbol] ┘ in Japanese means “electronic apparatus excellent in heat resistance” in English and ┌ [symbol] [symbol] [symbol] ┘ in Japanese means “electronic apparatus excellent in surge strength” in English.

In the following concrete example, it is assumed that there is stored in the bilingual dictionary storing section 120 the bilingual dictionary including three translation pairs:
┌ [symbol] heat resistance┘;
┌ [symbol] insulating film┘; and
┌ [symbol] electronic apparatus┘.

It should be noted that ┌ [symbol] ┘ in Japanese means “heat resistance” in English, ┌ [symbol] ┘ in Japanese means “insulating film” and ┌ [symbol] ∃ means “electronic apparatus” in English.

### (Operation of Fragment Pair Creating Section)

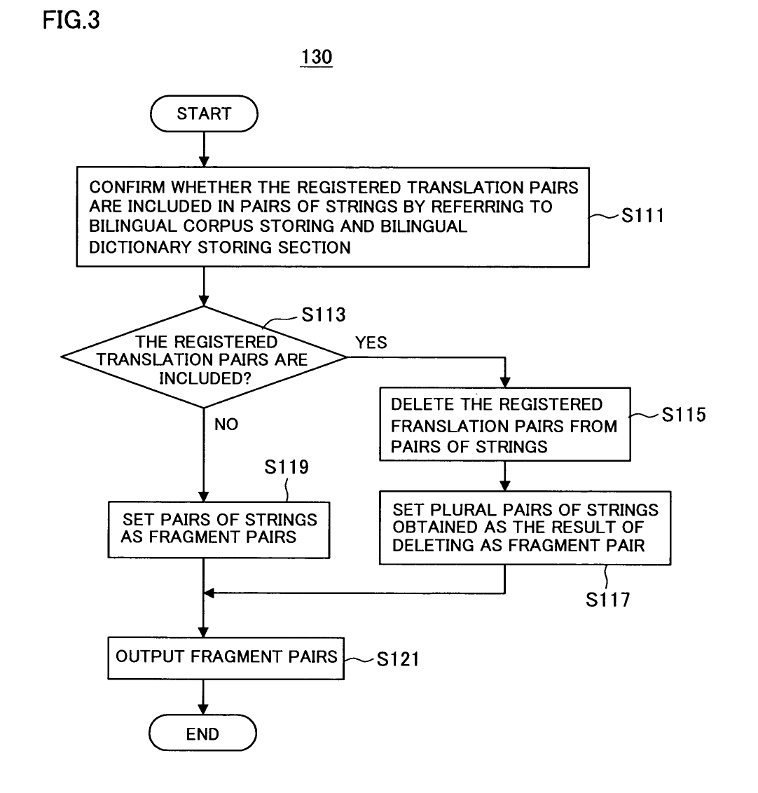

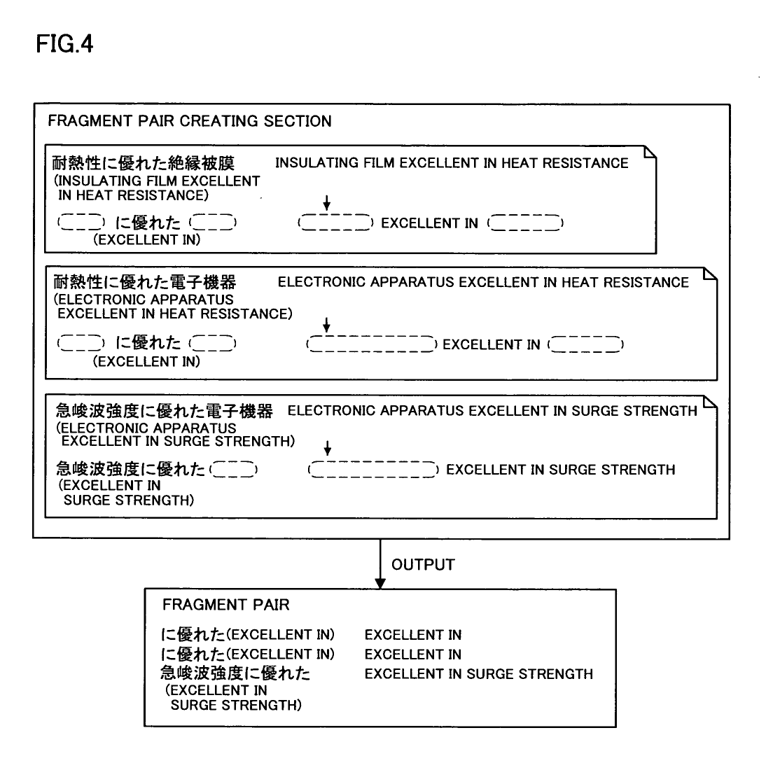

Hereinafter, the operation of the fragment pair creating section 130 according to this embodiment will be described in reference to FIGS. 3 and 4. FIG. 3 is a flowchart of an operation of the fragment pair creating section 130. FIG. 4 is a view showing a frame format of an operation of the fragment pair creating section 130.

The fragment pair creating section 130 confirms whether the translation pairs registered in the bilingual dictionary are included in the pairs of strings in the bilingual corpus by referring to the bilingual corpus storing section 110 and the bilingual dictionary storing section 120 (S111) to perform the following processes according to the result (S113).

When the translation pairs registered in the bilingual dictionary exist in the pair of strings, the registered translation pairs are deleted from the pairs of strings (S115). When the translation pairs are deleted from the pairs of strings, the pairs of strings are to be divided at the place where the translation pairs exist in the case where the deleted translation pairs exist in the place except for the end of the pair of strings. Then the fragment pair creating section 130 set as the fragment pair the pair of strings obtained as the result of deleting the translation pairs (S117).

More specifically, since the first pair includes two translation pairs; ┌ [symbol] heat resistance┘ and └ [symbol] insulating film┘, the fragment pair creating section 130 deletes these two translation pairs to create a new fragment pair, ┌ [symbol] excellent in┘, as shown in FIG. 4. It should also be noted that ┌ [symbol] ┘ in Japanese means “excellent in” in English.

Also, since the second pair includes two translation pairs; ┌ [symbol] [symbol] heat resistance┘ and ┌ [symbol] electronic apparatus┘, the fragment pair creating section 130 creates a new fragment pair, ┌ [symbol] [symbol] excellent in┘, as shown in FIG. 4.

Also, since the third pair includes a translation pair; ┌ [symbol] electronic apparatus┘, the fragment pair creating section 130 creates a new fragment pair, ┌ [symbol] [symbol] excellent in surge strength┘, as shown in FIG. 4.

On the other hand, when the translation pairs registered in the bilingual dictionary do not exist in the pairs of strings, the fragment pair creating section 130 sets the pairs of strings themselves as the fragment pairs (S119).

Then the fragment pair creating section 130 outputs the fragment pairs thus created to the fragment pair saving section 140 (S121).

In this embodiment, as shown in FIG. 4, the fragment pair creating section 130 outputs two fragment pairs of ┌ [symbol] excellent in┘ and one fragment pair of ┌ [symbol] [symbol] excellent in surge strength┘ to the fragment pair saving section 140.

### (Operation in Fragment Pair Saving Section)

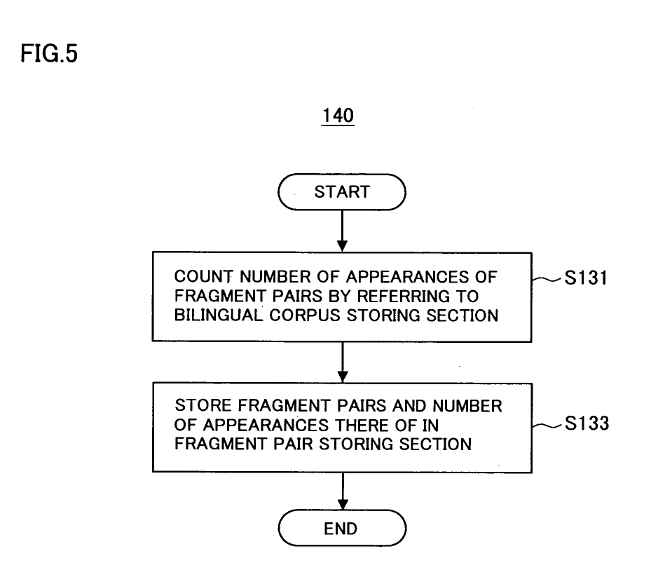

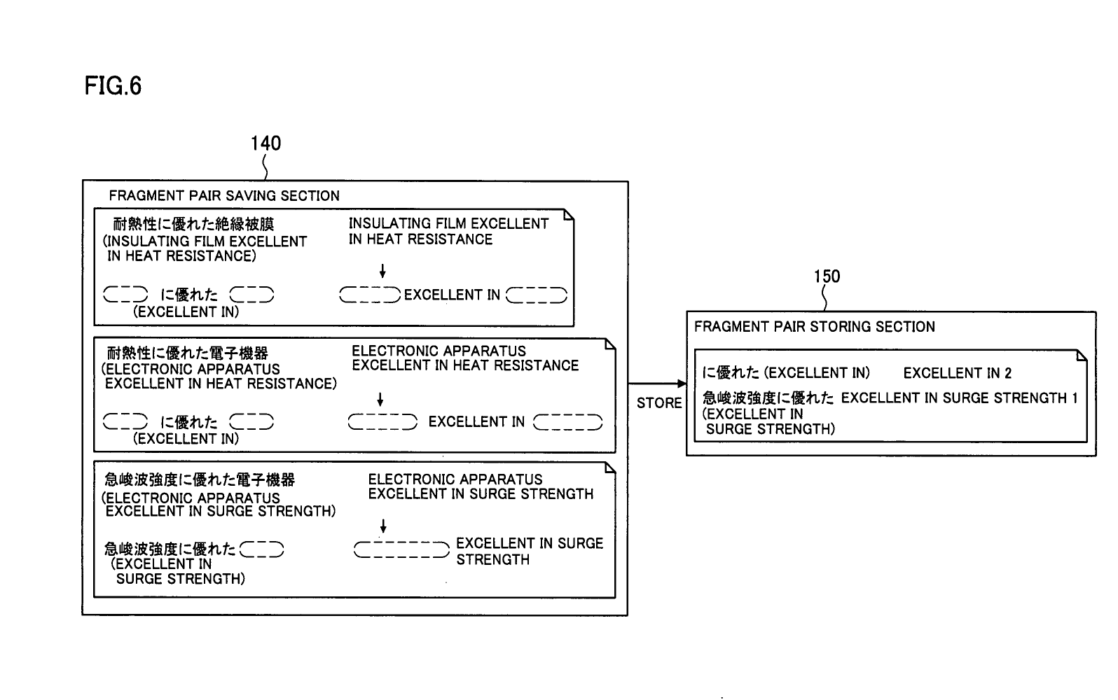

Hereinafter, the operation in the fragment pair saving section 140 according to this embodiment will be described in reference to FIGS. 5 and 6. FIG. 5 is a flowchart of an operation of the fragment pair saving section 140 according to this embodiment. FIG. 6 is a view showing a frame format of an operation of the fragment pair saving section 140 according to this embodiment.

When the fragment pairs are input from the fragment pair creating section 130, the fragment pair saving section 140 counts the number of appearances of the input fragment pairs in the pairs of strings in the stored bilingual corpus by referring to the bilingual corpus storing section 110 (S131).

More specifically, when the fragment pair ┌ [symbol] excellent in┘ is input, the fragment pair saving section 140 counts the number of appearances of the input fragment pair ┌ [symbol] excellent in┘ in all the pairs of strings in the bilingual corpus stored in the bilingual corpus storing section 110 by referring to the bilingual corpus storing section 110.

In the case of the bilingual corpus according to this embodiment, since the fragment pair saving section 140 can find two fragment pairs of ┌ [symbol] excellent in┘ and one fragment pair of ┌ [symbol] [symbol] excellent in surge strength by searching the pairs of strings in the bilingual corpus, the fragment pair saving section 140 ends the count.

Next, the fragment pair saving section 140 stores each of the fragment pairs input from the fragment pair creating section 130 in the fragment pair storing section 150, associating with the number of appearances in the bilingual corpus (S133).

In the case of this embodiment, as shown in FIG. 6, ┌ [symbol] excellent in┘ is to be stored in the fragment pair storing section 150, associated with the number of appearances, in this case, two, while ┌ [symbol] excellent in surge strength┘ is to be stored therein, associated with the number of appearances, in this case, one.

Since in a normal bilingual corpus there cannot be obtained so many examples as in the above by the fragment pairs including a technical term such as ┌ [symbol] [symbol] excellent in surge strength , counting information includes only small value. On the other hand, since a certain degree of examples can be obtained even by a small number of bilingual corpuses including the fragment pair that does not include a technical term ┌ [symbol] excellent in┘ without dependence on various fields such as electricity and chemistry, the number of appearances has large value.

### (Operation of Fragment Pair Extracting Section)

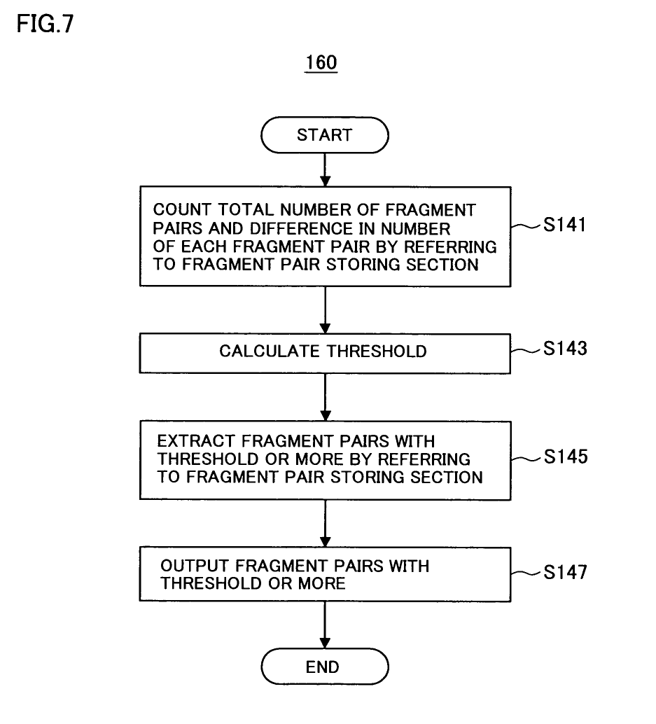

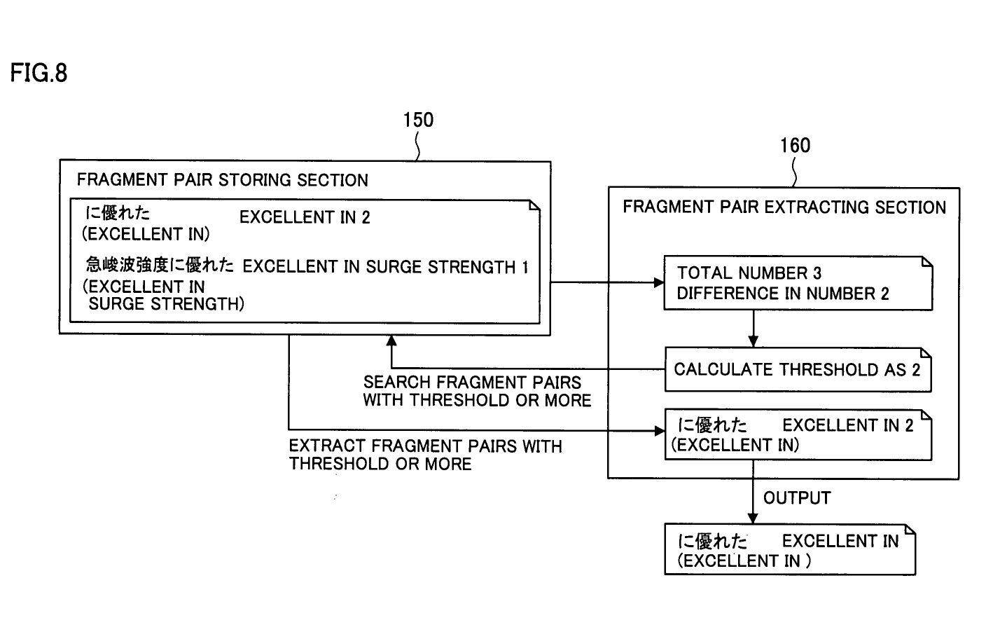

Hereinafter, the operation of the fragment pair extracting section 160 according to this embodiment will be described in reference to FIGS. 7 and 8. FIG. 7 is a flowchart of an operation of the fragment pair extracting section 160 according to this embodiment. FIG. 8 is a view showing a frame format of an operation of the fragment pair extracting section 160 according to this embodiment.

When there is stored in the fragment pair storing section 150 the fragment pair and the number of appearances thereof, associated with each other by the fragment pair saving section 140, the fragment pair extracting section 160 performs the following operations.

First, the fragment pair extracting section 160 counts the total number and difference in number of the fragment pairs saved in the fragment pair storing section 150 by referring to the fragment pair storing section 150 (S141). Here, a difference in number is the value indicating how many types of the fragment pairs including the same strings but different in number of letters are saved therein. In this embodiment, as shown in FIG. 8, the difference in number of the fragment pairs is two; ┌ [symbol] excellent in┘, and ┌ [symbol] [symbol] excellent in surge strength J while the total number of the fragment pairs is three; two ┌ [symbol] excellent in┘, and one ┌ [symbol] [symbol] [symbol] excellent in surge strength┘.

Next, the fragment pair extracting section 160 calculates a threshold with the predetermined method, based on the difference in number and the total number of the obtained fragment pairs (S143). In calculating the threshold, there may be performed a statistical processing by, for example, using the difference in number and the total number described above. In addition, the threshold may be calculated based on the value set by the method in which the number of appearances and appearance frequency of the phrase to be obtained as the dictionary-registration candidate can be freely set. For example, when the number of appearances of the phrase to be obtained is set at N, the calculated threshold may be 2N. In the next, the fragment pair extracting section 160 extracts the fragment pairs with the calculated threshold or more by referring to the fragment pair storing section 150, as shown in FIG. 8 (S 145), and the extracted fragment pairs are output to the dictionary-registration candidate creating section 170 (S147).

In this embodiment, assuming that the threshold is calculated as 2, the fragment pair extracting section 160 extracts the fragment pairs with the number of appearances two or more by searching the fragment pair storing section 150, as shown in FIG. 8. As a result, the fragment pair ┌ [symbol] excellent in ┘ with the number of appearances two is to be extracted by the fragment pair extracting section 160. In the next, the fragment pair extracting section 160 outputs this∉ [symbol] excellent in┘ to the dictionary-registration candidate creating section 170.

It should be noted that the fragment pair creating section 130 may output the number of the processed pairs of strings to the fragment pair saving section 140 and that the fragment pair extracting section 160 may calculate the threshold according to the number of the processed pairs of strings, the difference in number and the total number described above. In addition, there may be stored in the fragment pair storing section 150 the information on the size of fragment pairs such as numbers of kanji characters, katakana characters and hiragana characters in Japanese and number of words in Japanese and English other than the counting information, associated with the fragment pairs to use for the calculation of the threshold. The use of such a method makes it possible to control the condition of extraction in which a comparatively large fragment pair can be extracted even with small number of appearances while a comparatively small fragment pair cannot be extracted unless the number of appearances is further larger.

Although there has been described in the above that the threshold is calculated with the predetermined method, the user of the bilingual dictionary creating apparatus according to this embodiment may set the threshold freely to change freely the extraction level of the fragment pairs.

### (Operation of Dictionary-Registration Candidate Creating Section)

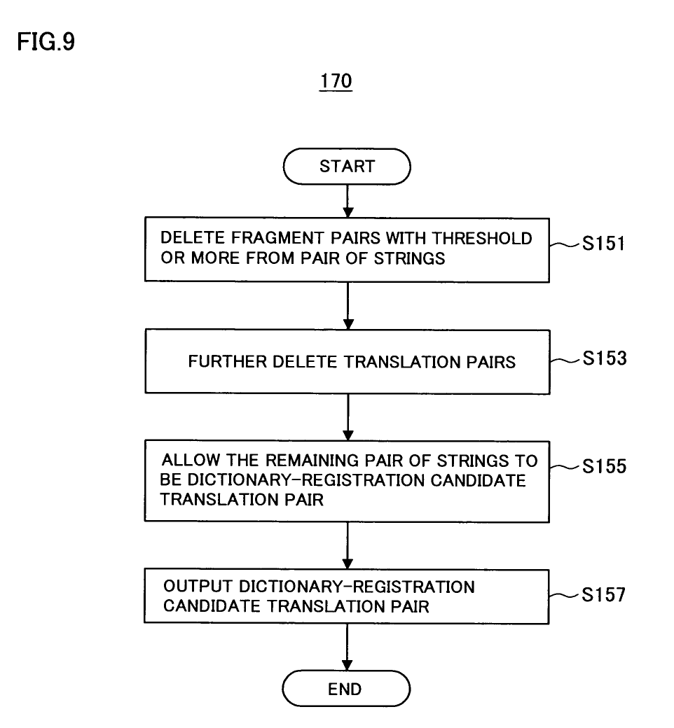

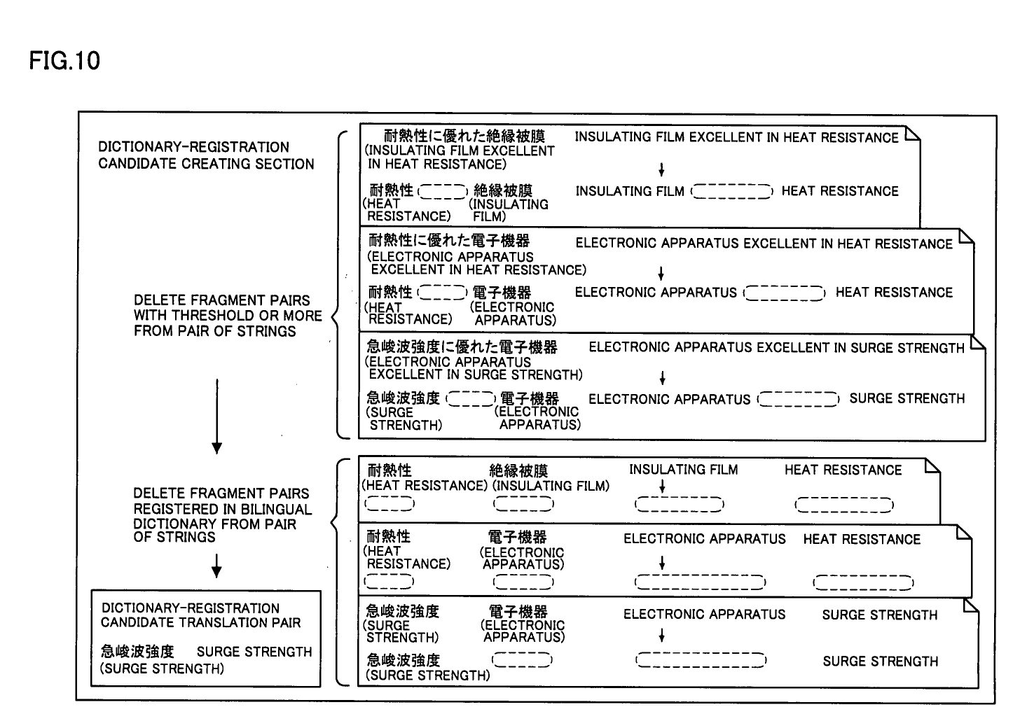

Hereinafter, the operation of the dictionary-registration candidate creating section 170 according to this embodiment will be described in reference to FIGS. 9 and 10. FIG. 9 is a flowchart of an operation of the dictionary-registration candidate creating section 170 according to this embodiment. FIG. 10 is a view showing a frame format of an operation of the dictionary-registration candidate creating section 170 according to this embodiment.

The dictionary-registration candidate creating section 170 checks the plural pairs of strings in the bilingual corpus one by one by referring to the bilingual corpus storing section 110 and deletes the fragment pairs input from the fragment pair extracting section 160 (S151).

As described above, there are included in the bilingual corpus three pairs of strings:
the first pair ┌ [symbol] [symbol] insulating film excellent in heat resistance┘;
the second pair ┌ [symbol] [symbol] electronic apparatus excellent in heat resistance┘; and
the third pair ┌ [symbol] [symbol] electronic apparatus excellent in surge strength┘;

In this embodiment, as shown in FIG. 9, the dictionary-registration candidate creating section 170 deletes the input fragment pair ┌ [symbol] excellent in┘ from the first pair. As a result, the first pair is divided into two parts, ┌ [symbol] insulating film heat resistance┘ and there remain two pairs of strings ┌ [symbol] heat resistance┘ and ┌ [symbol] insulating film┘ in the first pair.

Similarly in the second pair, the dictionary-registration candidate creating section 170 deletes the fragment pair ┌ [symbol] excellent in┘. As a result, there remain two pairs of strings ┌ [symbol] heat resistance┘ and ┌ [symbol] electronic apparatus┘.

Similarly in the third pair, the dictionary-registration candidate creating section 170 deletes the fragment pair ┌ [symbol] excellent in┘. As a result, there remain two pairs of strings ┌ [symbol] [symbol] electronic apparatus surge strength┘.

Next, the dictionary-registration candidate creating section 170 checks incomplete pairs of strings with the fragment pairs deleted input from the fragment pair extracting section 160 as shown in FIG. 10 and further deletes the translation pairs registered in the bilingual dictionary (S153). As the result of deleting, when the strings still remain in the pairs of strings, the dictionary-registration candidate creating section 170 allows the remaining strings to be the dictionary-registration candidate translation pair (S155) to output the dictionary-registration candidate translation pair (S157).

In this embodiment, the dictionary-registration candidate creating section 170 deletes ┌ [symbol] heat resistance┘ and ┌ [symbol] insulating film┘ from the first pair. As a result, there remain no pairs of strings in the first pair.

Similarly in the second pair, ┌ [symbol] heat resistance┘ and ┌ [symbol] [symbol] electronic apparatus┘ are deleted from the second pair, in which there remains no pairs of strings in the second pair as well.

In the third pair, however, when ┌ [symbol] electronic apparatus┘ is deleted from the third pair, ┌ [symbol] surge strength┘ is to remain. As a result, as shown in FIG. 10, the dictionary-registration candidate creating section 170 allows ┌ [symbol] [symbol] surge strength┘ to be the dictionary-registration candidate translation pair to output to the dictionary-registration candidate extracting section 180.

It should be noted that there may be newly created the bilingual corpus including plural pairs of strings shown in both a source language and a target language to use this bilingual corpus, with regard to the bilingual corpus referred to by the dictionary-registration candidate creating section 170.

### (Operation of Dictionary-Registration Candidate Extracting Section)

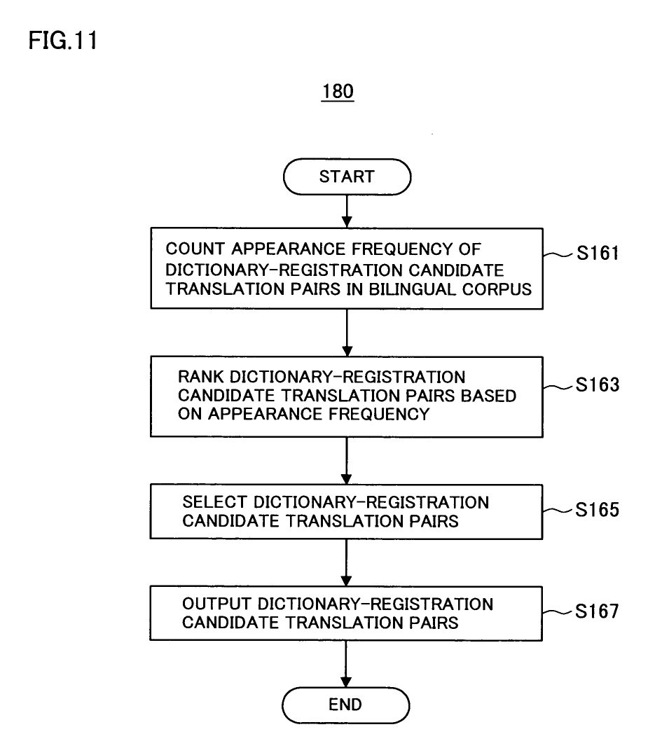

Hereinafter, the operation of the dictionary-registration candidate extracting section 180 according to this embodiment will be described in reference to FIG. 11. FIG. 11 is a flowchart of an operation of the dictionary-registration candidate extracting section 180 according to this embodiment.

The dictionary-registration candidate extracting section 180 counts the appearance frequency of the dictionary-registration candidate translation pairs in the stored bilingual corpus by referring to the bilingual corpus storing section 110 so as to narrow down the dictionary-registration candidate translation pairs input from the dictionary-registration candidate creating section 170 (S161). The bilingual corpus referred to for counting the appearance frequency may be prepared separately.

Next, the dictionary-registration candidate extracting section 180 ranks the dictionary-registration candidate translation pairs based on the counted appearance frequency (S 163). Then the dictionary-registration candidate extracting section 180 narrows down the dictionary-registration candidate translation pairs based on a predetermined standard (S 165) to output the result (S 167).

The method of ranking and narrowing down the dictionary-registration candidate translation pairs may be selected from various methods according to the purpose of use of the narrowed-down dictionary-registration candidate translation pairs. Hereinafter, although one example of the methods of ranking and narrowing down the dictionary-registration candidate translation pairs will be described showing concrete example, the method of narrowing down used in the dictionary-registration candidate extracting section 180 according to this embodiment is not restricted to the following example.

In technical terms in Japanese, the stems of the word used as a verb by being followed by an ending ┌ [symbol] and the word used as an adjective verb by being followed by an ending ┌ [symbol] ┘ can be regarded as a noun. Most of the technical terms to be subject to a new dictionary-registration can be regarded as a complex noun phrase with these nouns continued.

For example, with regard to the Japanese ┌ [symbol] ┘ in the dictionary-registration candidate translation pair ┌ [symbol] surge strength┘ in the above embodiment, ┌ [symbol] is a noun used as an adjective verb by being followed by the ending ┌ [symbol] ┘ while ┌ [symbol] ┘ and ┌ [symbol] ┘ [symbol] ┘ can be regarded as a common noun. Therefore, ┌ [symbol] ┘ is a complex noun phrase with three nouns continued.

For example, the corpus in Japanese with the same technical field as the bilingual corpus from which the dictionary-registration candidate translation pair is extracted may be scanned in advance to obtain the complex noun phrase with nouns continued along with the appearance frequency thereof and to narrow down the dictionary-registration candidate translation pairs to the Japanese word in the dictionary-registration candidate translation pair as a complex noun phrase with the appearance frequency at a certain degree or more.

Also, for example, the number of outputs of the dictionary-registration candidate translation pair is counted for each dictionary-registration candidate translation pair. There can be narrowed down to the translation pair with the most number of the outputs with regard to the dictionary-registration candidate translation pairs each having the same notations in Japanese.

Further, for example, the appearance frequencies of notations in Japanese and English in the bilingual corpus can be separately counted in advance to narrow down the dictionary-registration candidate translation pairs to the ones with comparatively small difference between Japanese notation and English notation.

When it is assumed that the dictionary-registration candidate translation pairs are complex noun phrases with nouns continued and the dictionary-registration candidate translation pairs are arranged in the order of Japanese words, for example, ┌ [symbol] [symbol] plasma display┘ is followed by ┌ [symbol] [symbol] LCD panel┘ and ┌ [symbol] [symbol] plasma display panel┘. It should be noted that ┌ [symbol] [symbol] ┘ in Japanese means “plasma display” in English and ┘ [symbol] [symbol] ┘ in Japanese means “plasma display panel” in English.

In the above case, there is narrowed down to the dictionary-registration candidate translation pair (in the above example, ┌ [symbol] [symbol] plasma display panel┘ configured by the Japanese (in the above example, ┌ [symbol] [symbol] ┘) including the Japanese word (in the above example, ┌ [symbol] [symbol] [symbol] ┘) in the preceding dictionary-registration candidate translation pairs and by the English (in the above example, “plasma display panel”) including the English word (in the above example, “plasma display”) in the preceding dictionary-registration candidate translation pairs.

In the above example, in other words, the follow-on dictionary-registration candidate translation pair ┌ [symbol] [symbol] [symbol] LCD panel┘, which includes the Japanese ┌ [symbol] [symbol] [symbol] ┘ with regard to the preceding dictionary-registration candidate translation pair ┌ [symbol] [symbol] plasma display┘, does not include the English “plasma display”. On the other hand, another follow-on dictionary-registration candidate translation pair ┌ [symbol] [symbol] plasma display panel┘ includes both the Japanese [symbol] [symbol] ┘ and the English “plasma display”. Therefore, there is to be narrowed down to ┌ [symbol] [symbol] plasma display panel┘ as the follow-on dictionary-registration candidate translation pair.

In addition, it is also possible to create a computer program for making a computer function as the bilingual dictionary creating apparatus according to this embodiment as described above. The computer program is stored in a storing section in the computer and makes the computer function as the bilingual dictionary creating apparatus by being executed upon loading by a CPU in the computer. In addition, there can be provided a recording medium with the computer program recorded and readable by a computer. The recording medium includes, for example, magnetic disk, optical disk and so on.

According to this embodiment, as described above, it is possible to extract almost automatically an unregistered translation pair with comparatively low degree of appearance frequency by using a bilingual corpus and an existing bilingual dictionary. As a result, there can be facilitated the creation of bilingual dictionary including technical term with low degree of appearance frequency that has been created by hand.

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

In this embodiment as described above, although the bilingual dictionary creating apparatus 100 is described by giving an example of using Japanese as a source language and English as a target language, the bilingual dictionary creating apparatus 100 according to this embodiment, which does not use phoneme information, can be used for other language pairs such as Japanese/Chinese and Japanese/Korean.

Also in the above embodiment, although there has been described the case where the bilingual corpus referred to by the fragment pair creating section 130 and the bilingual corpus referred to by the dictionary-registration candidate creating section 170 are the same, the bilingual corpuses referred to by the fragment pair creating section 130 and the dictionary-registration candidate creating section 170 may be different. For example, the fragment pair creating section 130 may create a fragment pair by referring to the bilingual corpus including a certain amount of pairs of strings while the dictionary-registration candidate creating section 170 may refer to another bilingual corpus including more pairs of strings. As this, separating the bilingual corpus referred to by the fragment pair creating section 130 from the bilingual corpus referred to by the dictionary-registration candidate creating section 170 makes it possible to obtain a dictionary-registration candidate translation pair.

In the fragment pair extracting section 160, in addition, after the fragment pairs having the number of appearances with the threshold or more are deleted from the fragment pairs stored in the fragment pair storing section 150 and the threshold is recalculated for the remaining fragment pairs to extract the fragment pairs having the number of appearances with the recalculated threshold or more, these fragment pairs having the number of appearances with the recalculated threshold or more are further deleted from the fragment pairs stored in the fragment pair storing section 150. Repetition of this operation makes it possible to search an unregistered translation pair with very small number of appearances.

What is claimed is;

1. A bilingual dictionary creating apparatus for creating a new bilingual dictionary by using a bilingual corpus including plural pairs of strings shown in both a source language and a target language and using an existing bilingual dictionary, the bilingual dictionary creating apparatus comprising:
a fragment pair creating section for creating a fragment pair by deleting a translation pair registered in the existing bilingual dictionary from the pairs of strings;
a fragment pair saving section for saving the fragment pair and the counted number of appearances of the fragment pair in the bilingual corpus in the storing section; and
a fragment pair extracting section for extracting the fragment pair having the number of appearances with a threshold or more from the storing section to create a dictionary-registration candidate translation pair.

2. The bilingual dictionary creating apparatus according to claim 1, wherein the fragment pair extracting section further deletes the dictionary-registration candidate translation pair from the fragment pair stored in the storing section to extract a new dictionary-registration candidate translation pair.

3. The bilingual dictionary creating apparatus according to claim 1, wherein the threshold is determined by a difference in number indicating the number of types of the fragment pair and a total number of the fragment pair.

4. The bilingual dictionary creating apparatus according to claim 1, wherein the bilingual corpus is created targeting a title of a technical literature shown in both the source language and the target language.

5. A bilingual dictionary creating apparatus for creating a new bilingual dictionary by using a bilingual corpus including plural pairs of strings shown in both a source language and a target language and using an existing bilingual dictionary, the bilingual dictionary creating apparatus comprising:
a fragment pair creating section for creating a fragment pair by deleting a translation pair registered in the existing bilingual dictionary from the pairs of strings;
a fragment pair saving section for saving the fragment pair and the counted number of appearances of the fragment pair in the bilingual corpus in the storing section;
a fragment pair extracting section for extracting the fragment pair having the number of appearances with a threshold or more from the storing section; and
a dictionary-registration candidate creating section for deleting the extracted fragment pair and the translation pair from the plural pairs of strings shown in both the input source language and target language.

6. The bilingual dictionary creating apparatus according to claim 5, wherein the fragment pair extracting section further deletes the dictionary-registration candidate translation pair from the fragment pair stored in the storing section to extract a new dictionary-registration candidate translation pair.

7. The bilingual dictionary creating apparatus according to claim 5, wherein the threshold is determined by a difference in number indicating the number of types of the fragment pair and a total number of the fragment pair.

8. The bilingual dictionary creating apparatus according to claim 5, wherein the bilingual corpus is created targeting a title of a technical literature shown in both the source language and the target language.

9. A bilingual dictionary creating method for creating a new bilingual dictionary by using a bilingual corpus including plural pairs of strings shown in both a source language and a target language and using an existing bilingual dictionary, the bilingual dictionary creating method comprising the steps of:
creating a fragment pair by deleting a translation pair registered in the existing bilingual dictionary from the pairs of strings;
saving the fragment pair and the counted number of appearances of the fragment pair in the bilingual corpus in the storing section; and
extracting the fragment pair having the number of appearances with a threshold determined by a predetermined method or more from the storing section to create a dictionary-registration candidate translation pair.

10. The bilingual dictionary creating method according to claim 9, further comprising a step of narrowing down the created plural dictionary-registration candidate translation pairs based on the appearance frequency in the bilingual corpus.

11. The bilingual dictionary creating method according to claim 9, wherein the threshold is determined by a difference in number indicating the number of types of the fragment pair and a total number of the fragment pair.

12. A bilingual dictionary creating method for creating a new bilingual dictionary by using a bilingual corpus including plural pairs of strings shown in both a source language and a target language and using an existing bilingual dictionary, the bilingual dictionary creating method comprising the steps of:
creating a fragment pair by deleting a translation pair registered in the existing bilingual dictionary from the pairs of strings;
saving the fragment pair and the counted number of appearances of the fragment pair in the bilingual corpus in the storing section;
extracting the fragment pair having the number of appearances with a threshold or more from the storing section; and
deleting the extracted fragment pair and the translation pair from the pairs of strings to create a dictionary-registration candidate translation pair.

13. The bilingual dictionary creating method according to claim 12, further comprising a step of narrowing down the created plural dictionary-registration candidate translation pairs based on the appearance frequency in the bilingual corpus.

14. The bilingual dictionary creating method according to claim 12, wherein the threshold is determined by a difference in number indicating the number of types of the fragment pair and a total number of the fragment pair.

15. A computer program for making a computer function as a bilingual dictionary creating apparatus for creating a new bilingual dictionary by using a bilingual corpus including plural pairs of strings shown in both a source language and a target language and using an existing bilingual dictionary, the computer program making the computer function as:
a fragment pair creating section for creating a fragment pair by deleting a translation pair registered in the existing bilingual dictionary from the pairs of strings;
a fragment pair saving section for saving the fragment pair and the counted number of appearances of the fragment pair in the bilingual corpus in the storing section; and
a fragment pair extracting section for extracting the fragment pair having the number of appearances with a threshold or more from the storing section to create a dictionary-registration candidate translation pair.

16. A computer program for making a computer function as a bilingual dictionary creating apparatus for creating a new bilingual dictionary by using a bilingual corpus including plural pairs of strings shown in both a source language and a target language and using an existing bilingual dictionary, the computer program making the computer function as:
a fragment pair creating section for creating a fragment pair by deleting a translation pair registered in the existing bilingual dictionary from the pairs of strings;
a fragment pair saving section for saving the fragment pair and the counted number of appearances of the fragment pair in the bilingual corpus in the storing section;
a fragment pair extracting section for extracting the fragment pair having the number of appearances with a threshold or more from the storing section; and
a dictionary-registration candidate creating section for deleting the extracted fragment pair and the translation pair from the plural pairs of strings shown in both the input source language and target language.
